(19) United States
(12) Patent Application Publication
(10) Pub. No.: US 2015/0100398 A1
(43) Pub. Date: Apr. 9, 2015

(54) Method for Dynamic Coupon Pricing

(71) Applicant: INTERNATIONAL BUSINESS MACHINES CORPORATION, Armonk, NY (US)

(72) Inventors: Chandrasekhar Narayanaswami, Somers, NY (US); Alan G. Cole, Somers, NY (US)

(73) Assignee: INTERNATIONAL BUSINESS MACHINES CORPORATION, Armonk, NY (US)

(21) Appl. No.: 14/049,121

(22) Filed: Oct. 8, 2013

(51) Int. Cl. G06Q 30/02

(52) U.S. Cl. CPC G06Q 30/0236; G06Q 30/0207; G06Q 30/0214; G06Q 30/0235
USPC 705/14.16; 705/14.1; 705/14.36; 705/14.35

(57) ABSTRACT

A method for dynamic coupon pricing includes steps of: receiving an indication of a trigger event regarding a value of a coupon; receiving an identification of the coupon; calculating a real-time value of the coupon by automatically updating the stated value of the coupon according to coupon price parameters; and providing the real-time value of the coupon.

### CROSS-REFERENCE TO RELATED APPLICATIONS

None.

### FIELD OF THE INVENTION

The disclosure disclosed broadly relates to the field of coupons, and more particularly relates to the field of dynamic coupon pricing.

### BACKGROUND OF THE INVENTION

A coupon is a certificate or token with a stated monetary value which is presented at the time of purchase of an eligible item, at which time the purchaser receives the stated discount. First introduced in the late 1800's as a promotional device for Coca-Cola, their use became widespread in the United States within the first decade of the 1900's, and has since grown into a global business with hundreds of billions of coupons distributed annually, and significant sums, both in terms of total discounts provided, and in revenues of companies involved in the coupon business.

The traditional coupon has been a paper coupon, often found in the Sunday newspaper or in direct mailings. The “Internet coupon” is a coupon which may be found on a web site or received by email, but it must be printed to be used, and after printing, it's life cycle is identical to that of the ordinary paper coupon.

It goes without saying that coupon, upon the face of which is printed a value, has a fixed and unvarying value. A coupon which states, for example, that a purchase is 30% off, may have a varying value depending on the current value of the eligible item, but still the percentage discount is fixed and unvarying.

Recently, though, all-digital coupons have been introduced. These do away with the paper altogether. Such coupons may be sent via email or by text messaging (SMS) or by multimedia messaging (MMS), or may be transferred to one's mobile digital wallet using Near Field Communications (NFC) chips or a subscriber identify module (SIM card), or by scanning a visible code (such as a QR code) from a printed medium or electronic display, or by codes printed in the invisible, such as ultra violet spectrum that can be read by a suitable reader, or by audio or visual tones/patterns that can be received and interpreted by a mobile device, or by a variety of other means, and may be linked to a retailer's loyalty card, or a subscriber's phone number. Such digital coupons may be redeemed by presenting one's mobile digital wallet or one's loyalty card, or showing a mobile phone displaying a barcode or textual coupon code, or giving one's phone number, or using a mobile application, or by a variety of other methods in practice. Coupons can be redeemed from a variety of devices as well, desktop computers, tablet devices, smart internet connected televisions, connected automobiles, and the like.

Until now, these digital coupons, like paper coupons, have all had fixed and unvarying discounts: either a fixed monetary value, or a fixed percentage discount. Because digital coupons are relatively new, there is little to no standardization. Methods of distribution include: SMS, MMS, email, Internet, WAP, Smartphone “wallet” app, 2D barcodes, NFC tapping on “smart poster”.

Methods of coupon redemption by customer include: use of loyalty card, showing barcode on mobile device, key fob, manual entry of code by clerk, providing phone number, tapping RFID or NFC tag on contactless POS terminal. However, there is still no widely agreed-upon process in the industry to process the digital coupon transaction (“clearing”). A common scenario for a digital coupon is where the digital coupon is sent to a consumer by one of: SMS or MMS; email; or Smartphone app. The consumer “accepts” the coupon which is then associated with the consumer's loyalty card (implies that coupons in this scenario are retailer-specific; retailer can use existing POS hardware). A loyalty card can be used at time of purchase; the discount is automatically applied. The back-end processing (“clearing”) is handled by a collaboration between the retailer's and coupon vendor's data processing systems. Reconciliation is all digital; there is little or no paper involved.

Digital coupon use is small but growing rapidly. Use of digital coupons grew by more than 100% from 1H 2009 to 1H 2010. Digital coupons now account for about 3% of all coupon use. In the United States, 10% of all mobile phone users, 20% of Smartphone users have used a mobile coupon this year. The redemption rate for digital coupons is often significantly higher than for paper coupons, highest if personalized.

Coupon fraud is estimated at $00 to $600 million/year in the United States. The types of fraud include: fraudulent practices by both end-consumers and by retailers; proper product not purchased; proper quantity not purchased; expired coupon; photocopied coupon; counterfeit coupon; and illegal (re-sold) coupons. With digital coupons vs. paper coupons, there is a greater potential to reduce fraud because each coupon can be assigned a unique id or a string of bits that can be verified by a back-end server. Additional verification can be performed by requesting more information from the person presenting the coupon. This can include PINs, passwords, biometrics, and other verification tools.

Fraud reduction measures include: automatic detection at POS of expiration date, and proper product(s)/amount(s) purchased; training of retail personnel; and consumer education. Digital coupons provide stronger security measures because they include a unique identifier and can be combined with a digital certificate.

Even with all of the fraud countermeasures in place today, perpetrators still find ways to commit coupon fraud. There exists a need for a system and method to overcome the shortcomings of the known art.

### SUMMARY OF THE INVENTION

Briefly, according to an embodiment of the disclosure a method for dynamic coupon pricing includes steps or acts of: receiving an indication of a trigger event regarding a value of a coupon; receiving an identification of the coupon; calculating a real-time value of the coupon by automatically updating the stated value of the coupon according to coupon price parameters; and providing the real-time value of the coupon.

According to another embodiment of the present disclosure, a method for dynamic coupon pricing includes steps or acts of: generating a user profile providing parameters for coupon redemption; receiving a notification of a trigger event related to coupon value, based on the user profile; and acknowledging receipt of the trigger event.

### BRIEF DESCRIPTION OF THE SEVERAL VIEWS OF THE DRAWINGS

To describe the foregoing and other exemplary purposes, aspects, and advantages, we use the following detailed description of an exemplary embodiment of the disclosure with reference to the drawings, in which:

FIG. 1 is a high level block diagram showing an information processing system configured to operate according to an embodiment of the present disclosure;

FIG. 2 is a simplified diagram of the dynamic coupon pricing method according to an embodiment of the present disclosure;

FIG. 3 is a diagram of coupon pricing evaluation, according to an embodiment of the present disclosure;

FIG. 4 is a low-level flowchart of the pricing evaluation according to an embodiment of the present disclosure;

FIG. 5 is a low-level flowchart of the pricing evaluation according to an embodiment of the present disclosure;

FIG. 6 is a low-level flowchart of the pricing evaluation according to an embodiment of the present disclosure;

FIG. 7 is a high-level flowchart of a method for dynamic coupon pricing, according to an embodiment of the present disclosure;

FIG. 8 is a simplified block diagram of an information processing configured to operate according to an embodiment of the present disclosure;

FIG. 9 is a flowchart of dynamic coupon pricing from the point of view of the coupon holder, according to an embodiment of the present disclosure; and

FIG. 10 is a simplified depiction of a user profile, according to an embodiment of the present disclosure.

While the disclosure as claimed can be modified into alternative forms, specific embodiments thereof are shown by way of example in the drawings and will herein be described in detail. It should be understood, however, that the drawings and detailed description thereto are not intended to limit the disclosure to the particular form disclosed, but on the contrary, the disclosure is to cover all modifications, equivalents and alternatives falling within the scope of the present disclosure.

### DETAILED DESCRIPTION

Before describing in detail embodiments that are in accordance with the present disclosure, it should be observed that the embodiments reside primarily in combinations of method steps and system components related to systems and methods for placing computation inside a communication network. Accordingly, the system components and method steps have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein. Thus, it will be appreciated that for simplicity and clarity of illustration, common and well-understood elements that are useful or necessary in a commercially feasible embodiment may not be depicted in order to facilitate a less obstructed view of these various embodiments.

We describe a method of dynamic coupon pricing wherein digital coupons feature a dynamically varying value. Because a digital coupon is not printed on paper, its value can be stored in a flexible format, with a link to a central, back-end service. The link is contained within the coupon itself. The value of the coupon varies depending on any of several different conditions which can be evaluated dynamically at the time of presentation and/or redemption of the coupon. Each digital coupon has an identifier that is recognized by the retailer.

In one embodiment of the disclosure, a remote (back-end) service calculates a value for the coupon in real-time, and then communicates that calculated value to the holder of the digital coupon. The back-end service may be offered by a retailer, manufacturer, or marketing agent. The methods used to calculate this changing value are not limited. For example, one retailer may wish to issue a coupon with an initial high value, which decreases over time, in order to encourage prompt purchase of an overstocked item. A manufacturer might wish to adjust the value of a coupon distribution, dividing total payout by the number of participants (to hold the manufacturer's costs constant), or increasing payout per coupon as the number of participants increases, to encourage the coupon to “go viral,” meaning to become popular in a short amount of time. Values may change dynamically during the day, to encourage shopping during otherwise slack times. Values may be automatically incremented if a product is mentioned on a social site. Multi-player games may provide coupon bonuses as prizes, with the value of the coupon being commensurate with the prize.

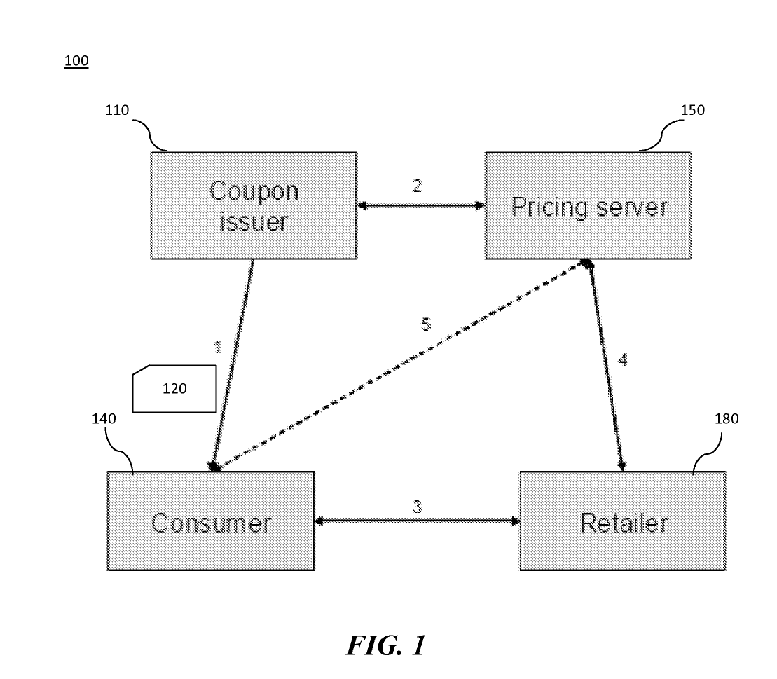

Referring now in specific detail to the drawings and to FIG. 1 in particular, we show a schematic diagram 100 of a dynamic coupon pricing system, according to one embodiment of the present disclosure. In this diagram 100, a “Coupon issuer” 110 distributes coupons 120 to consumers 140 (line 1) by any of several appropriate means, such as email, text message, NFC or SIM updates, or by linking such a coupon 120 to the consumer's loyalty card. At the same time, the issuer 110 notifies the pricing server 150 (line 2) that a coupon 120 has been issued.

The pricing server is a back-end, central server that computes the current (real-time) value of the coupon. For purposes of this disclosure the pricing server 150 is a computer system or network of computer systems. The pricing server 150 can be any programmable device including a client computer, a server computer, a portable computer, an embedded controller, a personal digital assistant, a Cloud computing device or an Internet-enabled television. It can be a stand-alone device or networked into a larger system.

Subsequently, at the time of purchase, the consumer 140 presents the appropriate instrument (e.g., loyalty card or NFC tag or mobile digital wallet) to the retailer's point of sale system 180, or the online store checkout page (line 3). The retailer's system 180 then contacts the pricing server 150 (line 4) and is informed of the value of the coupon 120. This discount is applied to the purchase, and the consumer 140 is informed (reverse direction of line 3).

An optional but highly desirable component of such a system is represented by line 5 in which the consumer 140 is able to enquire about the current value of the coupon 120, and to receive that information from the pricing server 150. Optionally, the server 150 may also send back information about the expected change in value, if the coupon issuer 110 decides this is a useful part of its marketing campaign. This may entail an ordinary Internet connection from a desktop or laptop computer, or from a mobile phone, or it may be an SMS text message from a phone, or by tapping an NFC-capable phone at a reader station, or by any of similar means of communication. There must be a central server 150 or perhaps a distributed array of servers 150 that compute the current value of a coupon 120. In some embodiments, the components represented by the coupon issuer 110 and the pricing server 150 will be merged, both under the control of the same company, perhaps a nationwide retailer.

There must be a two-way method of communication with a purchase end point (e.g., a POS terminal in a retail store, or a shopping cart on an online web store) in which the identity of the coupon 120 is made known to the central facility 150 and it in turn communicates the current value of the coupon 120 to the purchase end point. It is highly desirable, though not absolutely mandatory, that a reverse communication channel from the central facility to the end user exist, and that the current value of the coupon be communicated to this user. Again, an Internet connection, a web site, an SMS message, or even a phone call might all be used to communicate this information to the user.

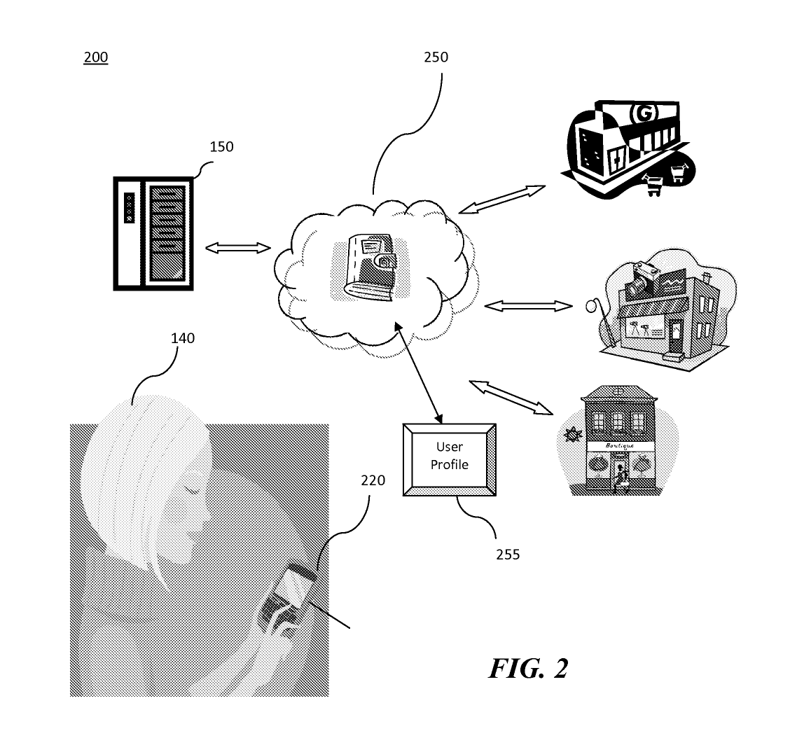

Referring now to FIG. 2 we show a dynamic coupon pricing environment 200 in which the present disclosure can be implemented. The coupon user 140 connects to his/her Cloud hosted coupon wallet 250 from his/her mobile device in order to determine the dynamic value of a coupon 120 at any point in time. In one embodiment, the dynamic value is calculated by the server 120 whenever an inquiry is made. In another embodiment, the computation of the coupon's value can be performed locally from a user's own device, without having to access the server 150. In this case, the coupon 120 has associated program code that can be executed locally at the user's device (mobile phone).

The user 140 may set rules as part of a user profile 255 generated in the coupon wallet 250 to receive notifications when coupon values reach a certain point. For example, for a coupon with a value that decrements over time, the user 140 may wish to be notified when the value falls below a certain amount, or when a certain amount of time has passed. Here the user's mobile device 220 contacts the remote server 110 which computes the current value of the coupon 120 in the coupon wallet 250. The coupon value depends on a variety of factors. For example, the value of the coupon may depend on: a) time decay—the value may increase or decrease over time; b) inventory; c) how many others are redeeming the coupon; d) mentions in a social network; e) a score in a multi-player game; f) weather; g) time of day; h) arbitrary business rules; i) post redemption re-evaluation.

To explain, post-redemption re-evaluation, consider that the value of some coupons can change post-redemption. For example, every coupon may have a fixed base value and a variable value that depends on the number of unit sales in a defined period. So if the manufacturer sells more, he is willing to give some additional discount. This type of pricing may incite users to promote the item to others in the hope that they will buy it, i.e., they can be advocate/influencers for the product.

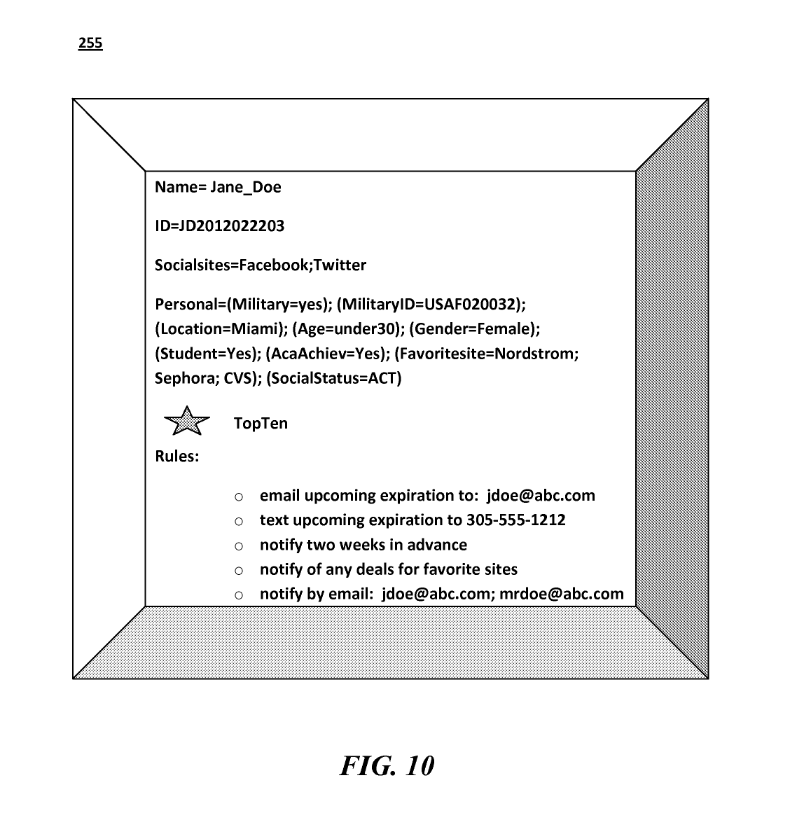

FIG. 10 shows a simplified illustration of the information that may be contained in a user profile 255. Identifying information for the user will generally be required. This information can be filled in by the user to generate the profile, or it can be derived from user cookies, networking sites, or other means. Because we are discussing coupon values that can dynamically changed based on multiple parameters, we need to include some of those parameters in the user profile 255. For example, we need to identify whether the user is a member of the military because coupon values can be tied to military service.

In addition, we can include information such as whether or not the user is a student. If the user is a student, a space to upload an indication of academic achievement is provided because coupon value can be tied to grades or other academic achievement, such as a pizza discount for reading a certain number of books. The academic achievement can be indicated by a digital stamp, QR (Quick Response) code or any other means as provided by the server 150, the retailer 180, or the issuer of the academic award.

The user profile 255 can also include a section for the user-defined rules related to coupon redemption and coupon notification. For example, the user profile 255 shown here indicates that Ms. Doe wishes to be notified two weeks in advance of any coupons and/or upcoming deals for her favorite stores. The notification is to be sent by email to her and her husband. If one of her coupons is about to expire, Ms. Doe wishes to receive an email and a text message about the expiration.

Much of the information contained in the user profile 255 can be derived without requiring explicit user input. For example, the name of the user 140, the user's social networking sites, and the user's favorite retailers can be derived from the user's computer (cookies, shopping history). This information can be supplied automatically and also updated automatically by tracking the user's on-line purchases and social networking sites.

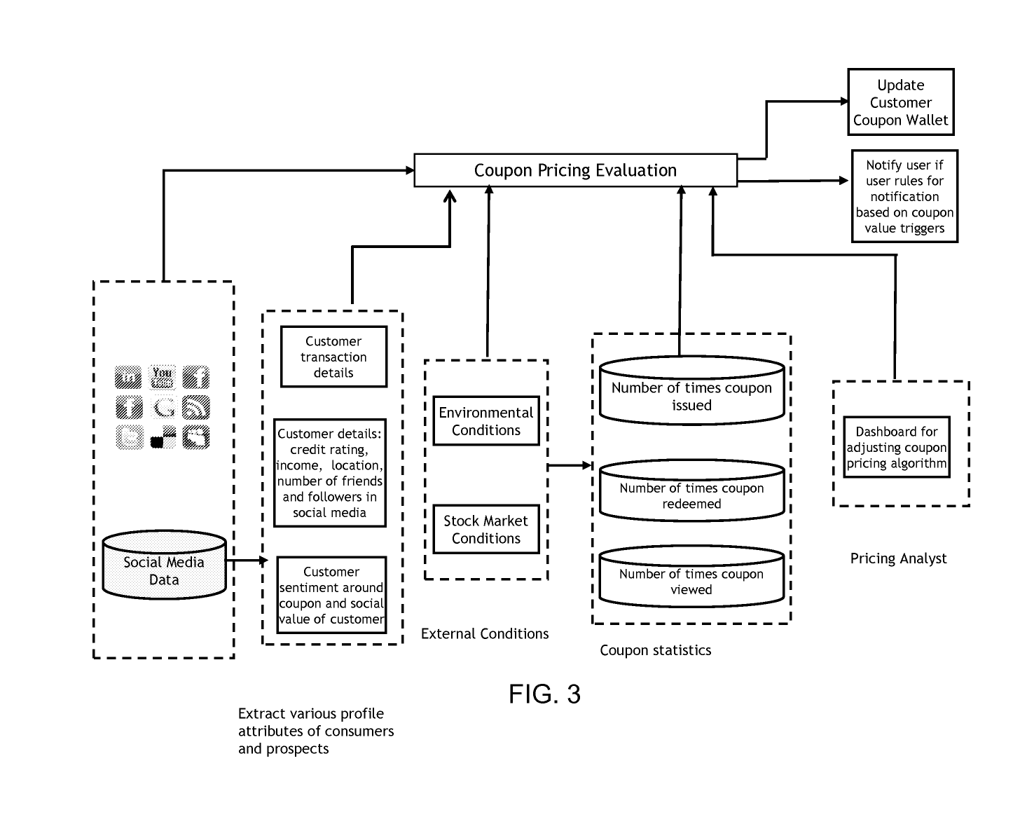

Referring now to FIG. 3 we describe coupon pricing evaluation according to an embodiment of the present disclosure proceeds with input from: a) social media; b) profile attributes of consumers and prospects; c) external conditions; d) coupon statistics; and e) a dashboard for adjusting coupon pricing algorithm. The coupon pricing engine 150 updates the customer's coupon wallet 250 and notifies the user 140 of any trigger events based on user rules for notification. As stated previously, the user rules can be part of the profile attributes contained in the user profile 255.

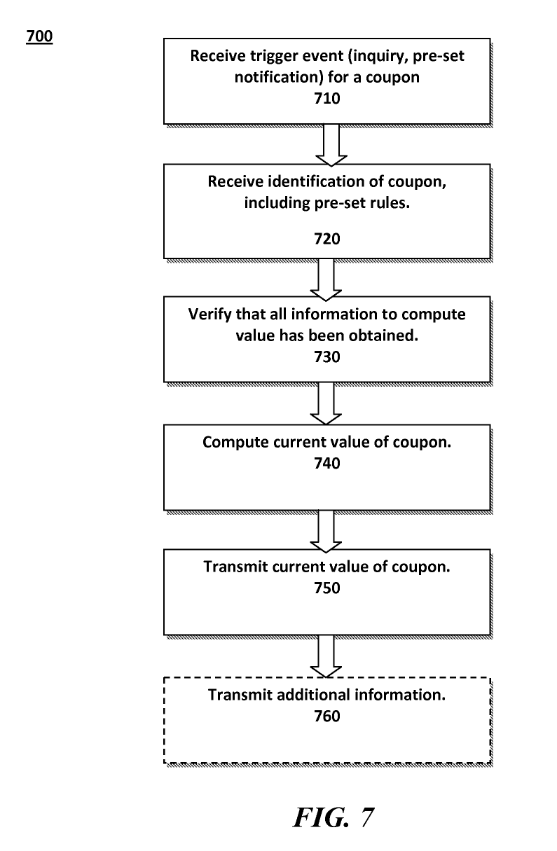

Referring now to FIG. 7 we show a high-level flowchart 700 of a method for dynamic coupon value, according to an embodiment of the present disclosure. This flowchart 700 is presented from the point of view of the pricing server 150. In step 710 the server 150 receives a coupon price trigger event. This trigger event can be a price inquiry from the coupon holder 140 or the retailer 180 where the coupon 120 is presented for redemption. In the first case the coupon holder 140 may wish to know how much the coupon 120 is worth at this point in time; and in the second case, the retailer 180 needs to know the value of the coupon 120 in order to adjust the price of the item associated with the coupon.

In step 720 the server 150 receives identifying information about the coupon 120 and any pre-set rules associated with the coupon 120. For example, the server 150 needs to know general information about the coupon 120, such as the coupon ID, expiration date, and associated trigger events, along with any user-defined “rules” such as “notify coupon holder when value reaches $$;” “notify coupon holder ten days before expiry;” and the like, from the user's coupon profile 255. All of this information can be stored in the user's coupon profile 255 along with information about the user 140. For example, if the coupon 120 features a pre-set rule that members of the military get an increased value, then the user coupon profile 255 is queried to determine if the user 140 is a member of the military. Another example of a change in coupon value tied to a user profile 255 is that students with good grades can get better coupons 120. The coupon holder's email address can also be included for notifications.

In step 730 the server 150 must verify that it has all of the information needed to compute the dynamic value of the coupon 120. For example, if the coupon value is time dependent, the server 150 needs to know the current time. If the coupon value is dependent upon consumer metrics, the server 150 must gather the consumer information that it needs. Once all of the information is available, the server 150 computes the current value of the coupon 120 based on the metrics that it has gathered. In step 750 the server 150 transmits the current value of the coupon 120.

Optionally, in step 760 the server 150 can also include information about the coupon 120 or its price determination. For example, the server 150 may wish to communicate that the coupon value was increased because the consumer is buying at off-peak hours.

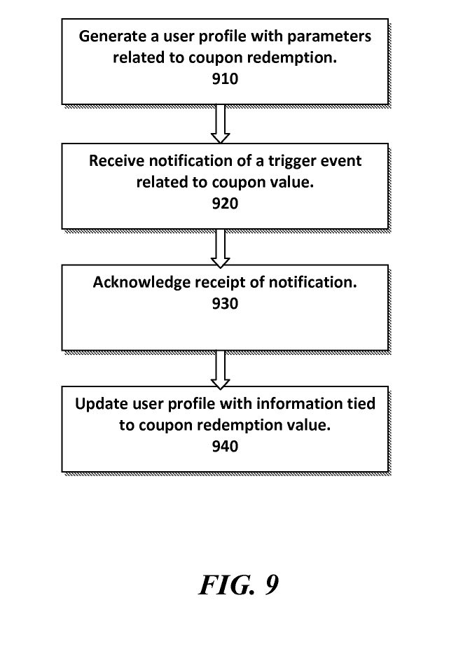

Referring now to FIG. 9 there is shown a high-level flowchart of the method for dynamic coupon pricing from the point of view of the user's device, according to embodiments of the present disclosure. In step 910 the profile 255 is generated with parameters that can be used to automatically and dynamically update the value of a coupon 120. As stated previously, these parameters can be explicitly input by the user, implicitly derived by the user's device, and/or a combination of the two.

In step 920 the user 140 receives a notification of a trigger event related to coupon value. This could be a notice that the coupon's value has changed, the coupon is soon to be expire, or any other coupon-related information. In step 930 the user 140 acknowledges receipt of this notice and in step 940 the profile 255 is updated with any other information that can affect coupon value, such as an academic merit achievement.

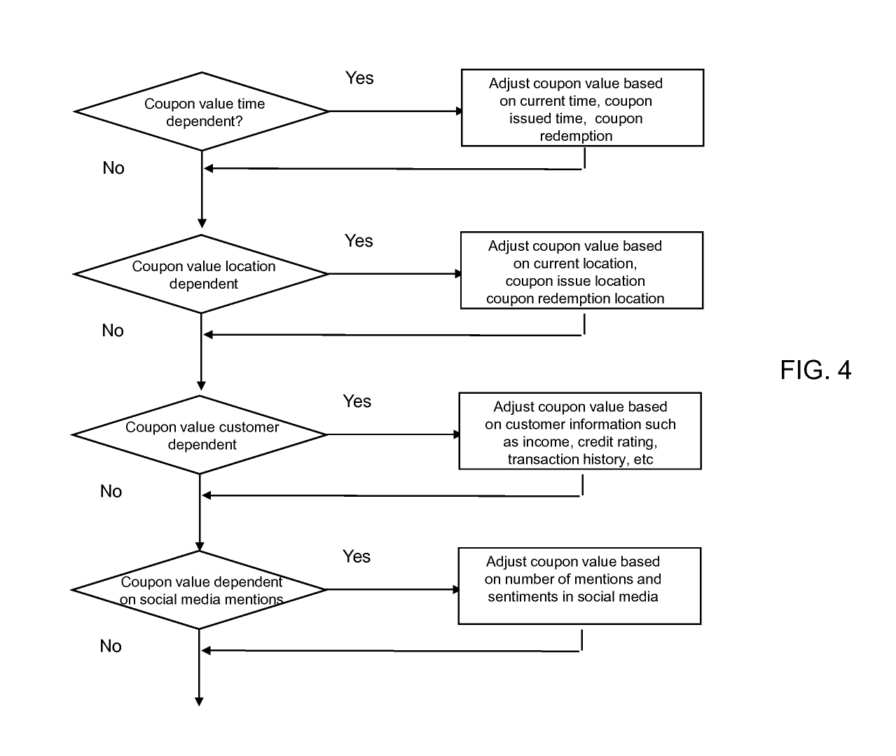

Referring now to the flowcharts of FIGS. 4, 5, and 6 we show lower-level flowcharts of the computation method of step 740 of FIG. 7 in the digital coupon pricing evaluation and adjustment method, according to embodiments of the present disclosure. Referring to FIG. 4, in step 410, we determine if the coupon value is time dependent. If Yes, in step 412 we adjust the coupon value based on the current time, the coupon issued time, and/or the coupon redemption time.

In step 420, we determine if the coupon value is location dependent. If Yes, in step 425 we adjust the coupon value based on the current location, the coupon issue location, and/or the coupon redemption location. In step 430 we determine if the coupon value is customer dependent. If Yes, then in step 435 we adjust the coupon value based on customer information derived from the user profile 255 and other means, such as income, credit rating, transaction history, age, gender, lifestyle segment, military status, grades, academic or sporting achievements, and other factors. We can factor in geo-demographic segments such as those provided by Nielsen PRIZM developed by Claritas, Inc. Nielsen PRIZM is used as a customer segmentation tool for marketing purposes. The segments are loosely based on US census data. Wikipedia provides these examples: “For instance, the segment The Cosmopolitans is defined as consisting of immigrants and descendants of multi-cultural backgrounds in multi-racial, multi-lingual neighborhoods. PRIZM has a specific set of ZIP Codes where The Cosmopolitans segment are predominant. Similarly, the segment Kids & Cul-de-Sacs is defined as consisting of suburban, upscale, married couples with children, typically within recently built subdivisions.”

In step 440 we determine if the coupon value is dependent on social media mentions. If Yes in step 445 we adjust the coupon value based on the number of mentions and sentiments in social media. Other criteria may include how the user 140 promoted the item in social media with videos, pinning it to other sites, and other promotional activities.

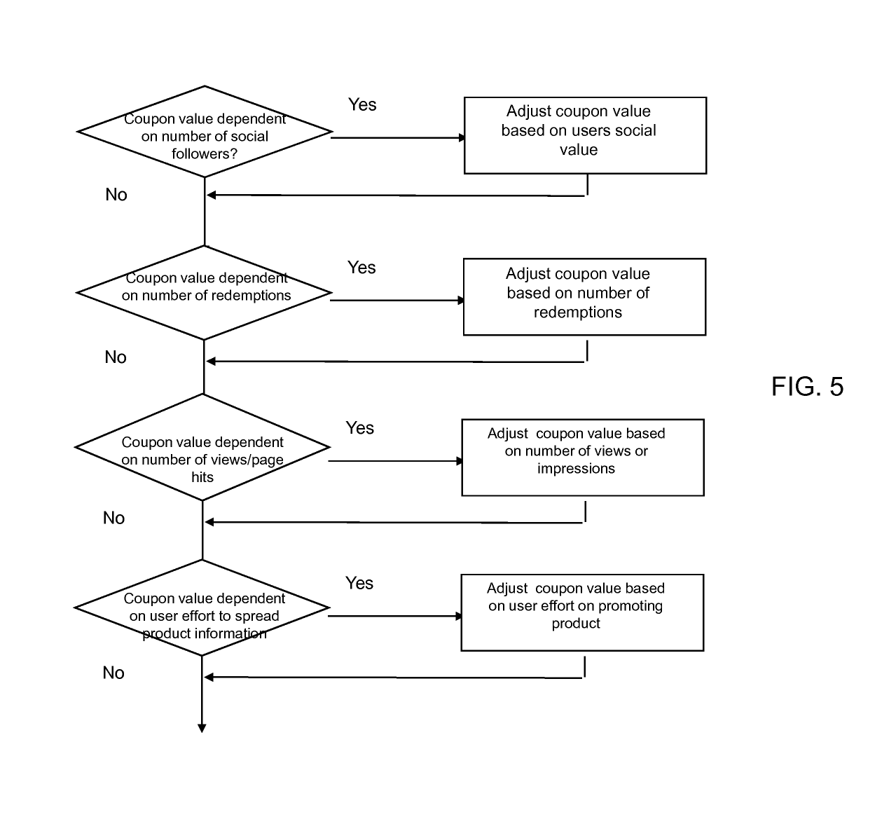

Continuing now to FIG. 5, in step 510 we determine if the coupon value is dependent on the number of social network followers. If Yes, in step 515 we adjust the coupon value based the user's perceived social value. In step 520 we determine if the coupon value is dependent on the number of redemptions. If Yes, in step 525 we adjust the coupon value based on the number of redemptions. In step 530 we determine if the coupon value is dependent on the number of views/page hits. If Yes, in step 535 we adjust the coupon value based on the number of views and/or impressions. In step 560 we determine if the coupon value is dependent on the user's effort to spread product information. If Yes, in step 565 we adjust the coupon value based on the user's effort in promoting the product.

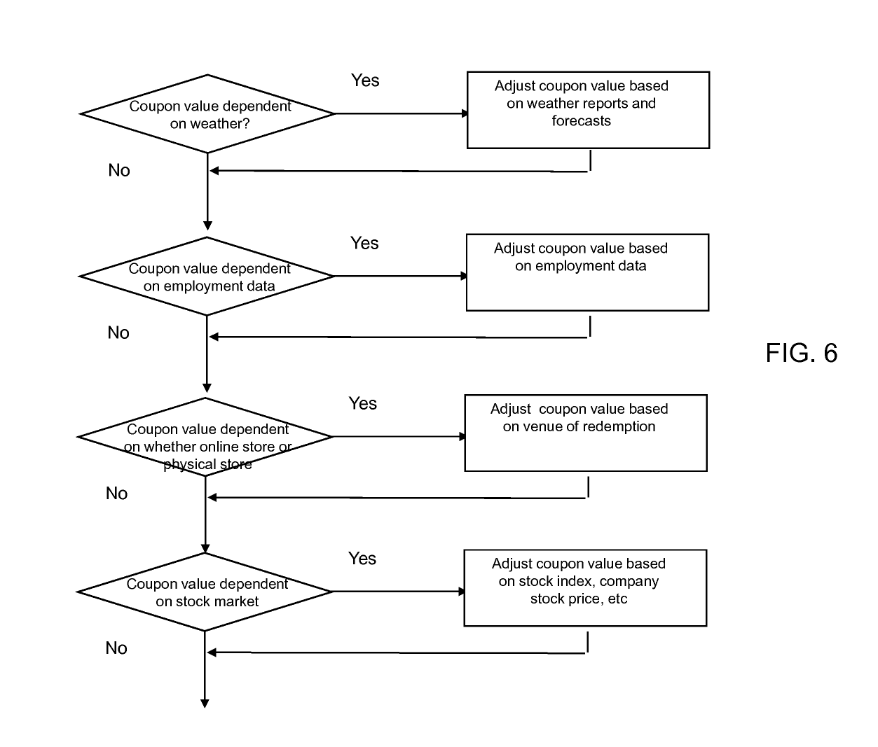

Continuing now to FIG. 6, in step 610 we determine if the coupon value is dependent on weather conditions. If Yes, in step 615 we adjust the coupon value based on weather reports and forecasts. In step 620 we determine if the coupon value is dependent on employment data. If Yes, in step 625 we adjust the coupon value based on employment data. In step 630 we determine if the coupon value is dependent on whether it is being redeemed at an online store or a physical (brick and mortar) store. If Yes, in step 635 we adjust the coupon value based on the venue of redemption. In step 640 we determine if the coupon value is dependent on the financial markets. If Yes, in step 645 we adjust the coupon value based on the stock index, company stock price, interest rates, etc.

Digital coupons afford many more opportunities for updating its value, and can provide the triggers to do so. Digital coupons can be targeted much more precisely than paper coupons in newspapers or magazines, to individual consumers. The targeting can be based on: user profile (age, gender, income, military status, grades, academic or sporting achievements, and other consumer parameters.); user location; user's purchase history; social network interactions; weather reports; time of day, time of week; user's wish list; current inventory levels at nearby retail outlet; and the like.

Hardware Embodiment.

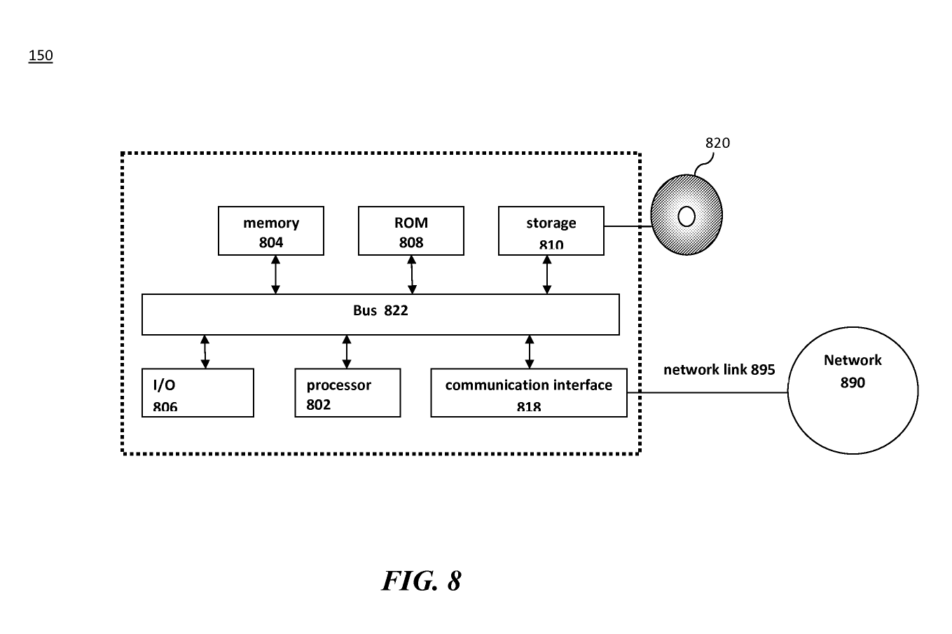

Referring now in specific detail to FIG. 8, there is provided a simplified high-level block diagram of the server 150 in which the present disclosure may be implemented. For purposes of this disclosure, computer system 150 may represent any type of computer, information processing system or other programmable electronic device, including a client computer, a server computer, a portable computer, an embedded controller, a personal digital assistant, Cloud computer, Internet-TV, and so on. The computer system 150 may be a stand-alone device or networked into a larger system. Computer system 150, illustrated for exemplary purposes as a networked server, is in communication with other networked computing devices (not shown) via network link 890. As will be appreciated by those of ordinary skill in the art, network 890 may be embodied using conventional networking technologies and may include one or more of the following: local area networks, wide area networks, intranets, public Internet and the like.

In general, the routines that are executed when implementing these embodiments, whether implemented as part of an operating system or a specific application, component, program, object, module or sequence of instructions, will be referred to herein as computer programs, or simply programs. The computer programs typically comprise one or more instructions that are resident at various times in various memory and storage devices in an information processing or handling system such as a computer, and that, when read and executed by one or more processors, cause that system to perform the steps necessary to execute steps or elements embodying the various aspects of the disclosure.

Throughout the description herein, an embodiment of the disclosure is illustrated with aspects of the disclosure embodied solely on computer system 150, for simplicity. As will be appreciated by those of ordinary skill in the art, aspects of the disclosure may be distributed among one or more networked computing devices which interact with computer system 150 via one or more data networks such as, for example, network 890. However, for ease of understanding, aspects of the disclosure have been described as embodied in a single computing device—computer system 150.

Computer system 150 includes processing device 802 which communicates with an input/output subsystem 806, memory 804, storage 810 and network 890. The processor device 802 is operably coupled with a communication infrastructure 822 (e.g., a communications bus, cross-over bar, or network). The processor device 802 may be a general or special purpose microprocessor operating under control of computer program instructions executed from memory 804 on program data. The processor 802 may include a number of special purpose sub-processors such as a comparator engine, each sub-processor for executing particular portions of the computer program instructions. Each sub-processor may be a separate circuit able to operate substantially in parallel with the other sub-processors.

Some or all of the sub-processors may be implemented as computer program processes (software) tangibly stored in a memory that perform their respective functions when executed. These may share an instruction processor, such as a general purpose integrated circuit microprocessor, or each sub-processor may have its own processor for executing instructions. Alternatively, some or all of the sub-processors may be implemented in an ASIC. RAM may be embodied in one or more memory chips.

The memory 804 may be partitioned or otherwise mapped to reflect the boundaries of the various memory subcomponents. Memory 804 may include both volatile and persistent memory for the storage of: operational instructions for execution by processor device 802, data registers, application storage and the like. Memory 804 may include a combination of random access memory (RAM), read only memory (ROM) and persistent memory such as that provided by a hard disk drive. The computer instructions/applications that are stored in memory 804, such as instructions for implementing the steps of FIGS. 4, 5, 6, and 7, are executed by processor 802. The computer instructions/applications and program data can also be stored in hard disk drive 810 for execution by processor device 802.

Those skilled in the art will appreciate that the functionality implemented within the blocks illustrated in the diagram may be implemented as separate components or the functionality of several or all of the blocks may be implemented within a single component. The I/O subsystem 806 may comprise various end user interfaces such as a display, a keyboard, and a mouse. The I/O subsystem 806 may further comprise a connection to a network 890 such as a local-area network (LAN) or wide-area network (WAN) such as the Internet.

The computer system 150 may also include storage 810, representing a magnetic tape drive, an optical disk drive, a CD-ROM drive, and the like. The storage drive 810, which can be removable, reads from and/or writes to a removable storage unit 820 in a manner well known to those having ordinary skill in the art. Removable storage unit 820, represents a compact disc, magnetic tape, optical disk, CD-ROM, DVD-ROM, etc. which is read by and written to by removable storage drive 810. As will be appreciated, the removable storage unit 820 includes a non-transitory computer readable medium having stored therein computer software and/or data for implementing the real-time feedback collection system.

The computer system 150 may also include a communications interface 818. Communications interface 818 allows software and data to be transferred between the computer system and external devices. Examples of communications interface 818 may include a modem, a network interface (such as an Ethernet card), a communications port, a PCMCIA slot and card, etc. Software and data transferred via communications interface 818 are in the form of signals which may be, for example, electronic, electromagnetic, optical, or other signals capable of being received by communications interface 818.

Therefore, while there has been described what are presently considered to be the embodiments of the disclosure, it will understood by those skilled in the art that other modifications can be made within the spirit of the disclosure. The above descriptions of embodiments are not intended to be exhaustive or limiting in scope. The embodiments, as described, were chosen in order to explain the principles of the disclosure, show its practical application, and enable those with ordinary skill in the art to understand how to make and use the system and method of the disclosure. It should be understood that this disclosure is not limited to the embodiments described above, but rather should be interpreted within the full meaning and scope of the appended claims.

We claim:

1. A method for dynamic coupon pricing, comprising:
using a processor device, performing steps of:
receiving an indication of a trigger event regarding a coupon, wherein said coupon is associated with a stated value;
receiving an identification of the coupon;
calculating a real-time value of the coupon by automatically updating the stated value of said coupon according to at least one of a plurality of coupon price parameters; and
providing the real-time value of the coupon.

2. The method of claim 1 further comprising:
receiving user profile parameters providing information about a holder of the coupon.

3. The method of claim 2 wherein calculating the real-time value comprises automatically updating the stated value based on at least one of the user profile parameters.

4. The method of claim 1 wherein calculating the real-time value comprises automatically updating the stated value based on metrics involving external conditions.

5. The method of claim 1 wherein calculating the real-time value comprises automatically updating the stated value based on metrics about the coupon.

6. The method of claim 2 wherein receiving the user profile parameters comprises receiving customer metrics selected from a group consisting of: credit rating, income, location, age, gender, lifestyle segment, gaming skills, grades, academic scores, and social media connections.

7. The method of claim 6 wherein calculating the real-time value comprises automatically updating the stated value depending on the user profile parameters selected from a group consisting of: a credit rating of the coupon holder, income of the coupon holder, military status, location, age, gender, lifestyle segment, gaming skills, grades, academic score of the coupon holder, and perceived social network value of the coupon holder,

8. The method of claim 4 wherein calculating the real-time value comprises automatically adjusting the stated value based on temporal metrics.

9. The method of claim 5 further comprising adjusting the real-time value of the coupon based on metrics selected from a group consisting of: a number of coupon holders, a number of coupon holders that can be evaluated, the coupon holder's efforts to further disseminate the coupon, post-redemption metrics, and mention of the product on an on-line social site.

10. The method of claim 4 further comprising updating the real-time value based on economic conditions selected from a group consisting of: stock prices, market indicators, unemployment figures, and interest rates.

11. The method of claim 6 further comprising updating the stated value based on location metrics selected from a group consisting of: a location where the coupon was acquired, a location of the coupon holder when the coupon was issued, a location of a place of redemption, and a location of the coupon holder at the occurrence of the trigger event.

12. The method of claim 1 wherein receiving the indication of the trigger event comprises receiving an inquiry about a value of the coupon.

13. A method for dynamic coupon pricing, comprising:
using a processor device, performing steps of:
generating a user profile providing parameters for coupon redemption;
receiving a notification of a trigger event related to a coupon, based on the user profile; and
acknowledging receipt of the trigger event.

14. The method of claim 13 wherein generating the user profile comprises providing information about a user's coupon notification and redemption preferences.

15. The method of claim 14 further comprising updating the user profile with an indicator of academic achievement.

16. The method of claim 13 further comprising receiving additional information comprising an expected change in value.

17. The method of claim 13 wherein generating the user profile comprises deriving information about the user without requiring user input.

18. The method of claim 17 wherein deriving the information comprises deriving favorite retailers of the user.

19. The method of claim 18 further comprising receiving coupons based on the derived favorite retailers.

20. The method of claim 13 wherein receiving the notification of the trigger event comprises receiving an indication that a coupon is about to expire.
